(19) United States
(12) Patent Application Publication
(10) Pub. No.: US 2019/0268606 A1
(43) Pub. Date: Aug. 29, 2019

(54) MOVING IMAGE ENCODING APPARATUS, CONTROL METHOD FOR MOVING IMAGE ENCODING APPARATUS, AND STORAGE MEDIUM

(71) Applicant: CANON KABUSHIKI KAISHA, Tokyo (JP)

(72) Inventor: Shogo Yamasaki, Kawasaki-shi (JP)

(21) Appl. No.: 16/285,466

(22) Filed: Feb. 26, 2019

(30) Foreign Application Priority Data
Feb. 27, 2018 (JP) 2018-033676

(51) Int. Cl. H04N 19/167; H04N 19/176; H04N 19/52; H04N 19/124

(52) U.S. Cl. CPC H04N 19/167; H04N 19/124; H04N 19/52; H04N 19/176

(57) ABSTRACT

A moving image encoding apparatus detects first motion information in units of blocks of a first size from a moving image; determines a region of interest from the moving image based on the first motion information; performs control such that a quantized value of a block determined as being the region of interest is set to a value lower than a quantized value of a block determined as not being the region of interest; detects second motion information in units of blocks of a second size that is smaller than the first size from the moving image, based on the first motion information; and performs compression encoding on the moving image based on the second motion information and the set quantized value.

### BACKGROUND OF THE INVENTION

### Field of the Invention

The present invention relates to a moving image encoding apparatus, a control method for a moving image encoding apparatus, and a storage medium, and in particular relates to a technique for relatively improving image quality of a region of interest in a moving image and suppressing encoding amounts in other regions.

### Description of the Related Art

A moving image signal encoding technique is used to perform transmission and storage/reproduction of a moving image. An international standardized encoding method such as the ISO/IEC International Standard 14496-2 (MPEG-4 Visual) is known as this kind of moving image encoding method. Also, H.264, H.265, which is the standard succeeding H.264, and the like, which are published by ITU-T and ISO/IEC, are known as other international standard encoding methods. In the present specification, ITU-T Rec. H.264 Advanced Video Coding|ISO/IEC International Standard 14496-10 (MPEG-4 AVC) will be referred to simply as H.264. Also, H.265 (ISO/IEC 23008-2 HEVC) will be referred to simply as H.265. These techniques are also used in the fields of video cameras, recorders, and the like, and particularly, in recent years, they have been actively applied to video cameras for monitoring (hereinafter referred to as monitoring cameras). In a monitoring camera application, there are many cases in which the size of the encoded data is suppressed by encoding with a comparatively low bit rate due to the need to perform long-term recording. However, a lot of information is lost through encoding at a low bit rate and the image quality deteriorates, and therefore original functions, such as specifying a person's face or specifying a number plate of an automobile, are impaired in some cases. In view of this, a technique of performing encoding such that entireties of frames are not uniformly encoded and regions of interest do not lose image quality, and performing encoding such that regions of non-interest have suppressed encoding amounts has been commonly used. For example, a region to be given attention, such as a moving object or a person, is detected as a region of interest, and the frame is divided into regions of interest and regions of non-interest.

Japanese Patent Laid-Open No. 6-30402 discloses a technique of determining whether or not each block of an input moving image is an important portion based on the occurrence of motion vectors conventionally used in compression encoding of a moving image, and controlling the compression rate such that the image quality of the important portion is detailed. Accordingly, for example, faces and motions of people can be captured in detail in the moving image of the monitoring camera, and the entirety can be recorded at a low bit rate for long-term recording.

However, in the conventional technique, the motion vectors used for encoding are not necessarily compatible with the actual motion information, and motions of pixels that are not important, such as sensor noise or shaking, are also determined as motions to be given attention on in some cases. For this reason, there is a problem in that erroneous detection of regions of interest increases.

The present invention has been made in view of the foregoing problem and provides a technique for reducing erroneous detection of a region of interest to efficiently reduce the bit rate.

### SUMMARY OF THE INVENTION

According to one aspect of the present invention, there is provided a moving image encoding apparatus, comprising: a first detection unit configured to detect first motion information in units of blocks of a first size from a moving image; a determination unit configured to determine a region of interest from the moving image based on the first motion information; a control unit configured to perform control such that a quantized value of a block determined as being the region of interest is set to a value lower than a quantized value of a block determined as not being the region of interest; a second detection unit configured to detect second motion information in units of blocks of a second size that is smaller than the first size from the moving image, based on the first motion information; and an encoding unit configured to perform compression encoding on the moving image based on the second motion information and the quantized value set by the control unit.

Further features of the present invention will become apparent from the following description of exemplary embodiments with reference to the attached drawings.

### BRIEF DESCRIPTION OF THE DRAWINGS

FIG. 1 is a functional block diagram of a moving image encoding apparatus according to an embodiment of the present invention.

FIG. 2 is a flowchart showing a procedure of processing implemented by the moving image encoding apparatus according to an embodiment of the present invention.

FIG. 3 is a diagram showing an example of a range for performing large block motion detection, according to an embodiment of the present invention.

FIG. 4 is a diagram showing an example of a large block motion detection method and output motion vectors, according to an embodiment of the present invention.

FIG. 5 is a diagram showing an example of a range for performing small block motion detection and output motion vectors, according to an embodiment of the present invention.

FIG. 6 is a diagram showing an example of an input moving image according to an embodiment of the present invention.

FIG. 7 is a diagram showing an example of region-of-interest determination processing using small block motion vectors, according to an embodiment of the present invention.

FIG. 8 is a diagram showing an example of region-of-interest determination processing using large block motion vectors, according to an embodiment of the present invention.

FIG. 9 is a diagram showing an example of masking processing for low-order bits, performed when calculating an SAD according to an embodiment of the present invention.

FIG. 10 is a flowchart showing an example of a hardware configuration of the moving image encoding apparatus according to an embodiment of the present invention.

### DESCRIPTION OF THE EMBODIMENTS

An exemplary embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

In the present embodiment, an example will be described in which erroneous detection is suppressed and a region of interest is estimated by determining the position of the region of interest in a moving image to be encoded, based on a motion vector detected in units of large blocks from the moving image. It should be noted that a region of interest is a region that is also referred to as an ROI (Region of Interest), and is a region that is to be given attention during monitoring or the like. For example, a region of interest is a region that corresponds to an object detected by a recognition unit or an object detection unit that performs image analysis. Also, any position may be designated as a region of interest by the user.

Apparatus Configuration

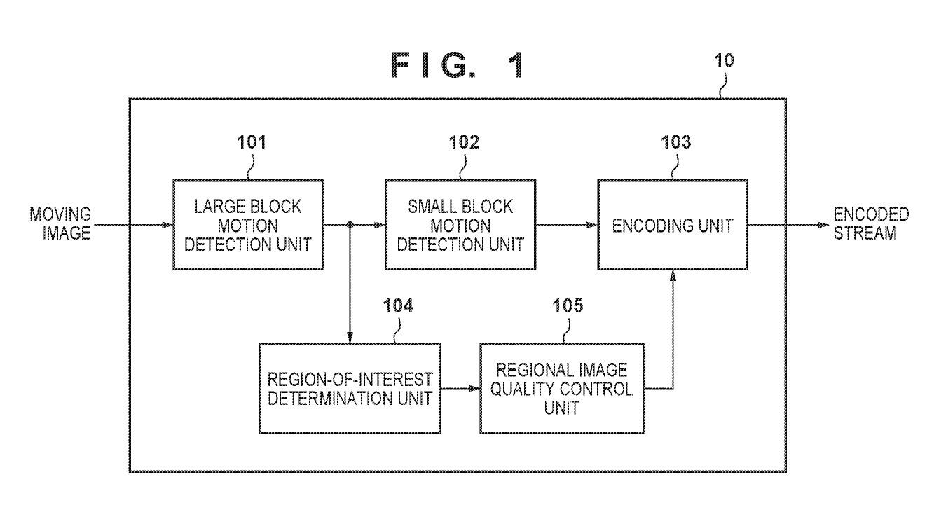

FIG. 1 is a functional block diagram of a moving image encoding apparatus according to the present embodiment. The moving image encoding apparatus 10 compresses and encodes an input moving image (captured moving image) in units of frames and outputs an encoded stream in H.265 format. Note that in the present embodiment, the stream to be output is in H.265 format, but the present invention is not limited thereto. For example, it is also possible to use an encoded stream in H.264 format or MPEG-4 format. The moving image encoding apparatus 10 compresses and encodes the captured moving image to be encoded, in units of Coding Tree Units (hereinafter, CTUs) in the H.265 format. Note that in the present embodiment, the moving image is divided into units of CTUs, but the present invention is not limited to this, and for example, it is also possible to divide the moving image into units of macroblocks in H.264. Also, in the present embodiment, the size of a CTU is 64×64, but the present invention is not limited thereto, and it is also possible to use 32×32 or 16×16. Furthermore, the moving image encoding apparatus 10 sets image quality parameters (quantized values) for adjusting the image quality in units of CTUs, and thereby performs encoding such that the encoding amount is suppressed for a region of non-interest in the moving image, and performs encoding such that the image quality does not decrease in the region of interest. A quantized value is also referred to as a quantization parameter, and defines the quantization step. For example, the smaller a quantized value is, the smaller the quantization step is, and the higher the image quality is as a result.

The moving image encoding apparatus 10 according to the present embodiment includes: a large block motion detection unit 101; a small block motion detection unit 102; an encoding unit 103; a region-of-interest determination unit 104; and a regional image quality control unit 105.

The large block motion detection unit 101 performs motion search in units of CTUs in the captured moving image and calculates motion vectors with a precision in units of single pixels. In the present embodiment, the motion search is performed in units of CTUs, but the present invention is not limited thereto, and it is also possible to perform searching with a size larger than that of the CTU, and to perform searching in units of macroblocks. In the present embodiment, the motion vectors to be calculated are in units of pixels, but there is no limitation to this, and the units of the motion vectors to be calculated may also be smaller than one pixel or larger than one pixel. If they are smaller than one pixel, the motion vectors will have decimal precision. The motion vector calculated by the large block motion detection unit 101 is output to the small block motion detection unit 102 and the region-of-interest determination unit 104.

The small block motion detection unit 102 further calculates the motion vectors in units of small blocks based on the motion vectors calculated by the large block motion detection unit 101. Then, based on these motion vectors, the CTUs are divided into Prediction Units (hereinafter, PUs) in the H.265 format. The motion vectors calculated by the small block motion detection unit 102 are output to the encoding unit 103.

The encoding unit 103 performs motion compensation, quantization, and entropy encoding based on the motion vectors output from the small block motion detection unit 102 and the quantized values output from the later-described region-of-interest determination unit 104, and outputs an H.265-format encoded stream.

The region-of-interest determination unit 104 determines the region to be given attention in the captured moving image based on the motion vectors output from the large block motion detection unit 101 and outputs region-of-interest determination information. In the present embodiment, if the size of the motion vector is not 0, the block is determined as a region of interest.

If the regional image quality control unit 105 determines that a block to be encoded is a region of interest based on the region-of-interest determination information output from the region-of-interest determination unit 104, the quantized value of the block is set such that its image quality is higher than that of blocks determined as not being regions of interest. On the other hand, if the block to be encoded is determined as not being a region of interest, the quantized value of the block is set such that its image quality is lower than that of a block determined as being a region of interest.

Here, with reference to FIG. 10, an example of a hardware configuration of the moving image encoding apparatus according to the first embodiment will be described. The moving image encoding apparatus 10 includes a CPU 1001, a ROM 1002, a RAM 1003, a storage apparatus 1004, and a bus 1005, and is connected to an input apparatus 1006 and a display apparatus 1007.

The CPU 1001 controls various operations performed by the above-described functional blocks of the moving image encoding apparatus 10 according to the present embodiment. The control content is instructed using a later-described program in the ROM 1002 or the RAM 1003. Also, the CPU 1001 can cause multiple calculator programs to operate in parallel. The ROM 1002 stores the calculator programs, which store procedures for control performed by the CPU 1001, and data. The RAM 1003 stores the control program to be processed by the CPU 1001 and provides a work region for various types of data for when the CPU 1001 executes various types of control. The function of the program code stored in the storage medium such as the ROM 1002 or the RAM 1003 is realized by the CPU 1001 performing readout and execution, but the type of the storage medium does not matter.

The storage apparatus 1004 can store various types of data and the like. The storage apparatus 1004 includes: a storage medium such as a hard disk, a floppy disk, an optical disk, a magnetic disk, a magneto-optical disk, a magnetic tape, or a non-volatile memory card; and a drive for storing information by driving the storage medium. The stored calculator program and data are called to the RAM 1003 when needed, through an instruction from a keyboard, or an instruction from various types of calculator programs.

The bus 1005 is a data bus that is connected to the constituent elements, realizes communication between the constituent elements, and is for rapidly realizing information exchange. The input apparatus 1006 provides various input environments depending on the user. Considering that various input operation environments are provided, a keyboard, mouse, and the like are conceivable, but it is also possible to use a touch panel, a stylus pen, and the like. The display apparatus 1007 is constituted by an LED display or the like and displays the state of various input operations and calculation results corresponding thereto. Note that the configuration described above is an example and there is no limitation to the described configuration.

Processing

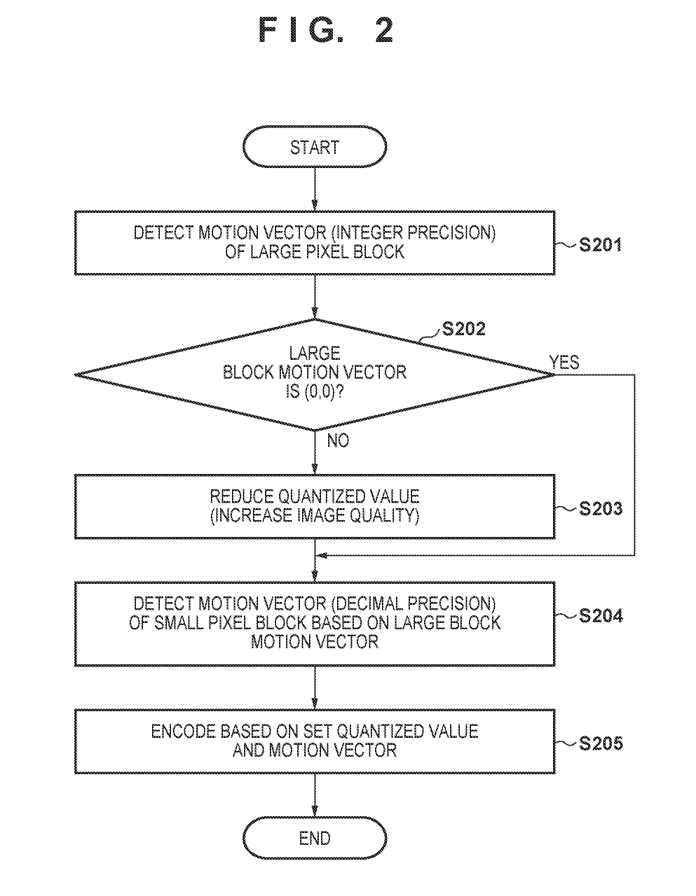

Next, with reference to the flowchart in FIG. 2, a procedure of processing implemented by the moving image encoding apparatus according to the present embodiment will be described.

In step S201, the large block motion detection unit 101 performs a motion search in units of CTUs (in units of blocks of a first size), and calculates motion information (first motion vectors) with a precision in units of single pixels (integer precision). Also, the calculation result is output to the small block motion detection unit 102 and the region-of-interest determination unit 104.

In step S202, the region-of-interest determination unit 104 determines the region to be given attention in the captured moving image based on the motion information (first motion vectors) output from the large block motion detection unit 101. In the present embodiment, if the size of the first motion vector is not zero, the block to be encoded is determined as a region of interest, and the processing moves to step S204. On the other hand, if the size of the first motion vector is zero, the block to be encoded is determined as a region of non-interest, and the processing moves to step S204. However, the present invention is not limited thereto. For example, if the size of the first motion vector exceeds a threshold set in advance, the block may be determined as a region of interest.

In step S203, the regional image quality control unit 105 sets the quantized value for a block determined as being a region of interest by the region-of-interest determination unit 104 to a low value, such that its image quality is higher than that of a block determined as not being a region of interest. Also, the regional image quality control unit 105 outputs the set quantized value to the encoding unit 103.

In step S204, the small block motion detection unit 102 further performs motion search in units of small blocks (in units of blocks of a second size that is smaller than the first size) based on the motion information (first motion vector) calculated by the large block motion detection unit 101. Then, motion information with decimal precision (second motion vectors) is calculated. Also, the small block motion detection unit 102 outputs the calculated second motion vectors to the encoding unit 103. Note that if the size of the first motion vector is 0 (S202; Yes), the block to be encoded is determined as a region of non-interest, and therefore the processing of step S204 is executed with the quantized value left unchanged.

In step S205, the encoding unit 103 performs motion compensation, quantization, and entropy encoding based on the second motion vectors output from the small block motion detection unit 102 and the quantized values output from the regional image quality control unit 105. Then, an H.265-format encoded stream is output. It should be noted that if the size of the first motion vector is 0 (S202; Yes), the block to be encoded is determined as a region of non-interest, and therefore the predetermined quantized value is output to the encoding unit 103 from the regional image quality control unit 105 without changing the quantized value. With that, the series of processes shown in FIG. 2 ends.

It should be noted that in the present embodiment, the large block motion detection unit 101 calculates the first motion vectors with an integer precision and the small block motion detection unit 102 calculates the second motion vectors with a decimal precision, but the present invention is not limited thereto. As long as the size of the large block (first size) is larger than the size of the small block (second size), motion vectors with any kind of precision may be calculated.

Motion Detection Processing

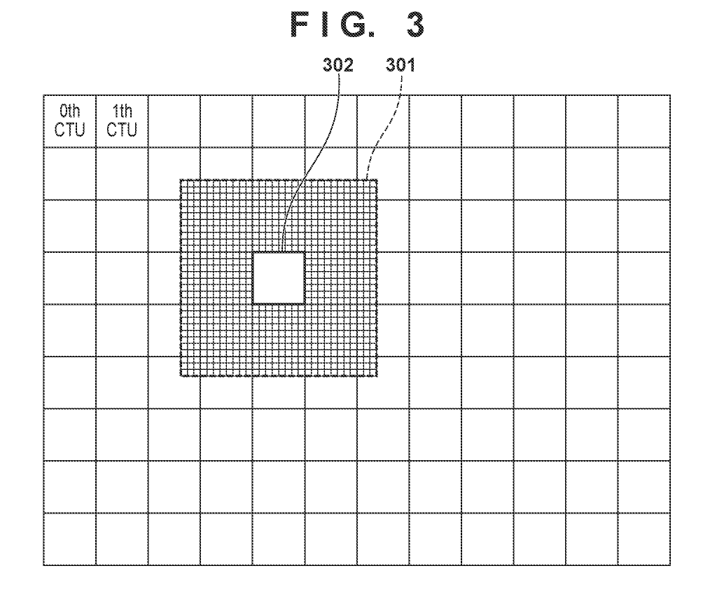

Next, processing for large block motion detection in the present embodiment and processing for small block motion detection will be described in detail. FIG. 3 shows a frame of a moving image, and a range 301 surrounded by a dotted line is a range of performing motion detection for a large block (in the present embodiment, a CTU 302). Blocks that are even smaller than the CTU 302, which are inside of the dotted line, are minimum units for motion prediction (hereinafter, small blocks), and the small block motion detection processing is performed in units of small blocks. The size of the small block of the present embodiment is 8×8, but the present invention is not limited thereto, and for example, the size may be 16×16 or 4×4.

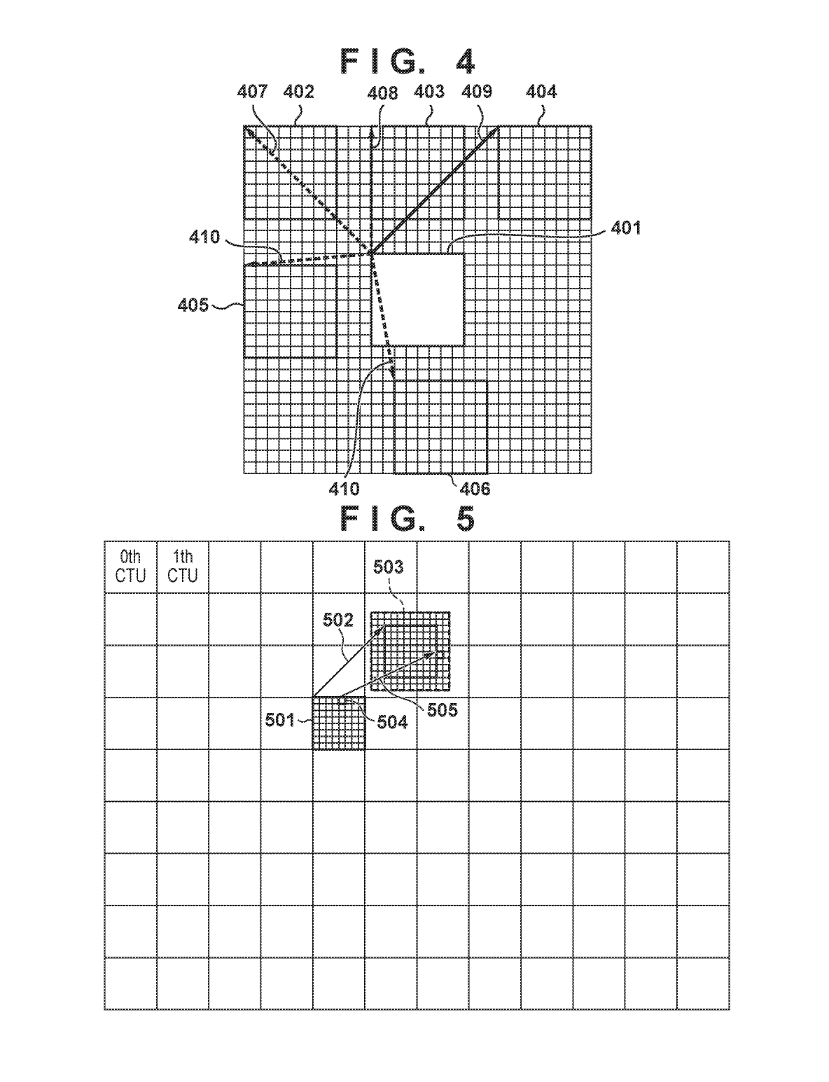

First, processing for large block motion detection will be described. A block similar to the CTU 302 in the frame to be encoded is searched for in the range surrounded by the dotted line of another frame to be referenced. It should be noted that in the present embodiment, searching is performed using the CTU size, but the present invention is not limited thereto. For example, the size of a large block may also be determined according to the resolution of the frame and the spatial frequency of the pixels. At this time, as shown in FIG. 4, the pixel values are sequentially compared while moving the CTU 401 in the range of performing large block motion detection, and the sum of absolute differences (SAD), which means the absolute difference sum, is calculated for each block size that is the same as that of the CTU. The SAD is defined using the following equation.

$$\begin{matrix}Equation 1 & \\ SAD = {\sum }_{x , y} \vert Diff ( x , y ) \vert & ( 1 )\end{matrix}$$

Diff(x,y) indicates the difference between the pixel value of the frame to be encoded and the pixel value of another frame to be referenced at the coordinates (x,y) of a pixel in the moving image. In the drawing, motion vectors 407 to 410 corresponding to the blocks 402 to 406, for example, are determined. If the position of the block at which the SAD is at a minimum is specified as being the block 404, the block 404 is set as a similar block. Then, the information on the relationship between the coordinates of the current CTU and the similar block is the motion vector 409 (first motion vector) output by the large block motion detection unit 101. That is, the large block motion detection unit 101 detects the block of the second frame that is similar to the block of the first size of the first frame included in the moving image, and detects the first motion vector between the blocks as the motion information.

Note that in the present embodiment, an example has been described in which the motion vector of the large block is calculated using the SAD, but the present invention is not limited thereto. For example, the motion vector may also be calculated using a cost obtained by adding the bit amount of the motion vector to the SAD.

Next, small block motion detection processing will be described with reference to FIG. 5. In a current CTU 501, motion detection for small blocks (e.g., 504) is performed within the range 503 of the dotted line (±X pixels from the coordinates indicated by the motion vector output by the large block motion detection unit 101), based on the motion vector 502 output by the large block motion detection unit 101. In the small block motion detection, the second motion vectors (e.g., the motion vector 504) are calculated in units of small blocks in the range 503 of the dotted line. That is, the blocks of the second frame, which are similar to the blocks of the second size obtained by dividing the blocks of the first size in the first frame, are detected in a predetermined range based on the coordinates indicated by the motion vector output by the large block motion detection unit 101. Then, the motion vectors between the blocks are detected as the motion information.

It should be noted that the size of a small block may also be determined according to the resolution of the frame and the spatial frequency of the pixels, similarly to the large blocks. In the small block motion detection, pixel values are sequentially compared while moving within a search range, and the SAD is calculated for each motion vector. Next, the motion vector of a peripheral 8×8 block, and the bit amount and SAD of the motion vector are added, whereafter the size of the PU (Prediction Unit) and the motion vector of the PU are determined such that the minimum cost is reached. The determined motion vector is output from the small block motion detection unit 102. Note that the motion vector output from the small block motion detection unit 102 has decimal precision.

In this manner, first, wide-range motion search is performed using large blocks, and then narrow-range motion search is performed using small blocks, and thus the processing time required for motion search can be suppressed. Furthermore, dividing the processing has an effect of making pipelining easier and leads to an improvement in throughput.

In the present embodiment, a region of interest is determined using the motion vector output from the large block motion detection unit 101, but the following will describe the reason why erroneous detection of the region of interest decreases due to increasing the block size when searching for motion vectors.

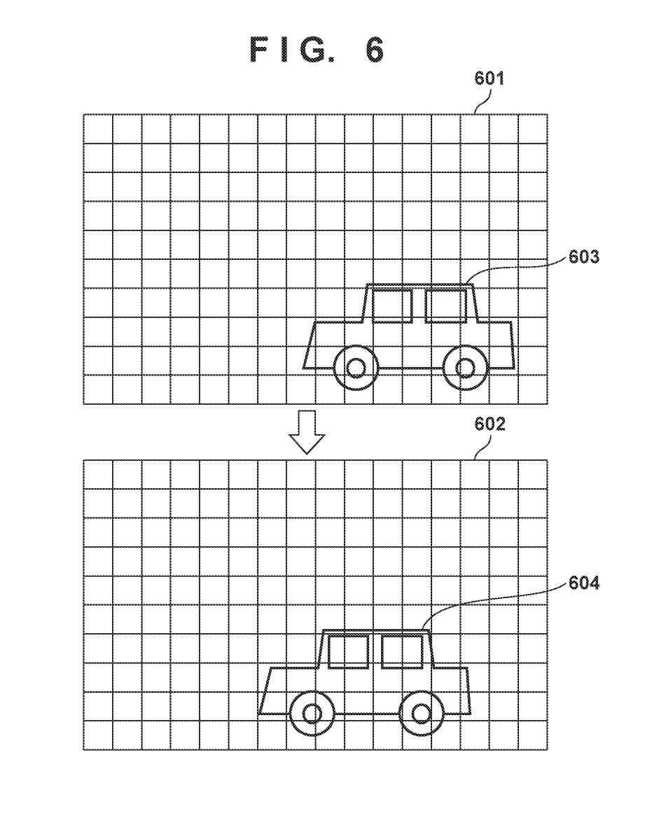

First, a case will be described in which determination of the region of interest is performed based on the small block motion vector. The image 601 and the image 602 of FIG. 6 have a temporal correlation in which the lower moving image is captured one frame later than the upper moving image. An automobile 603 is included in the image 601, and an automobile 604 is included in the image 602.

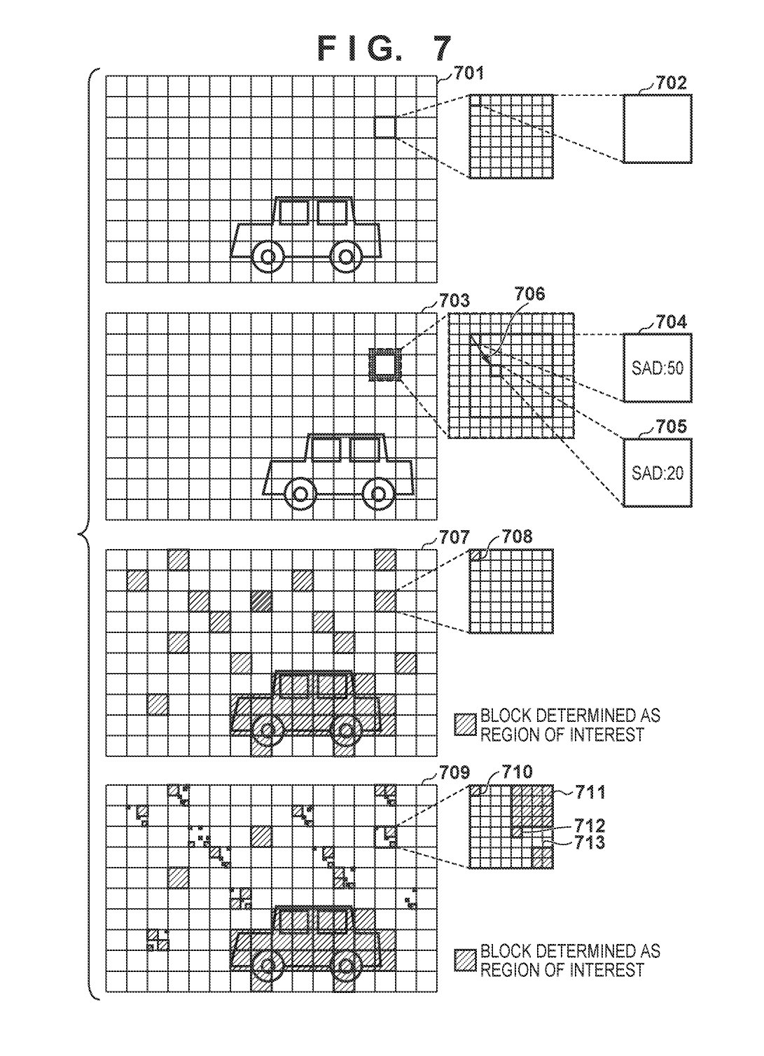

Also, an image 701 shown in FIG. 7 corresponds to the image 602 shown in FIG. 6, and hereinafter encoding will be performed on a small block 702 in the frame currently being encoded.

Since the automobile in the moving image including the image 703 and the image 701 moves from right to left and motion vectors occur, the automobile is determined as a region of interest by the region-of-interest determination unit 104. However, it is assumed that the motion vector of the large block was (0,0) in the CTU to which the small block 702 belongs. Thereafter, a detailed motion search using the small blocks is performed. If the small block 704 and the small block 705 of the image 703 are candidates for being similar blocks, the small block 705 with a small SAD is selected as a similar block (here, the SAD of the small block 704 is 50, and the SAD of the small block 705 is 20). Upon doing so, the motion vector 706 of the small blocks is generated. This is because if the block for searching for motion is small, it is likely to be influenced by the pixel value changing under the influence of sensor noise. As a result, as shown in the image 707, regions of interest and regions of non-interest 708 are distinguished between using the obtained motion vectors 706 of the small blocks, and conventionally, there tend to be many needless regions of interest that are not necessary, which tends to lead to erroneous detection of the regions of interest.

The image 707 shows an example in which a quantized value is set in units of CTUs, and if even one small block motion vector is generated in a CTU, that block is determined as a region of interest. Note that the determination may also be performed according to the percentage at which the small blocks in the region of interest were generated in the CTU.

The image 709 shows an example in which the region of interest is determined for each small block. The region of interest is determined according to whether or not there is a small block motion vector in the CTU, and according to the PU size. Although omitted in the image 707, if it is assumed that the small block motion vectors have occurred as in the PUs 711 to 713 in addition to the PU 710, needless regions of interest that originally are not necessary occur due to the influence of noise, even if the size for distinguishing between regions of interest is made small as in the image 709. An example is shown in which the PU 711 is set to a 32×32 pixel size, the PU 713 is set to a 16×16 pixel size, and the PU with the same size as the CTU is set to a 64×64 pixel size.

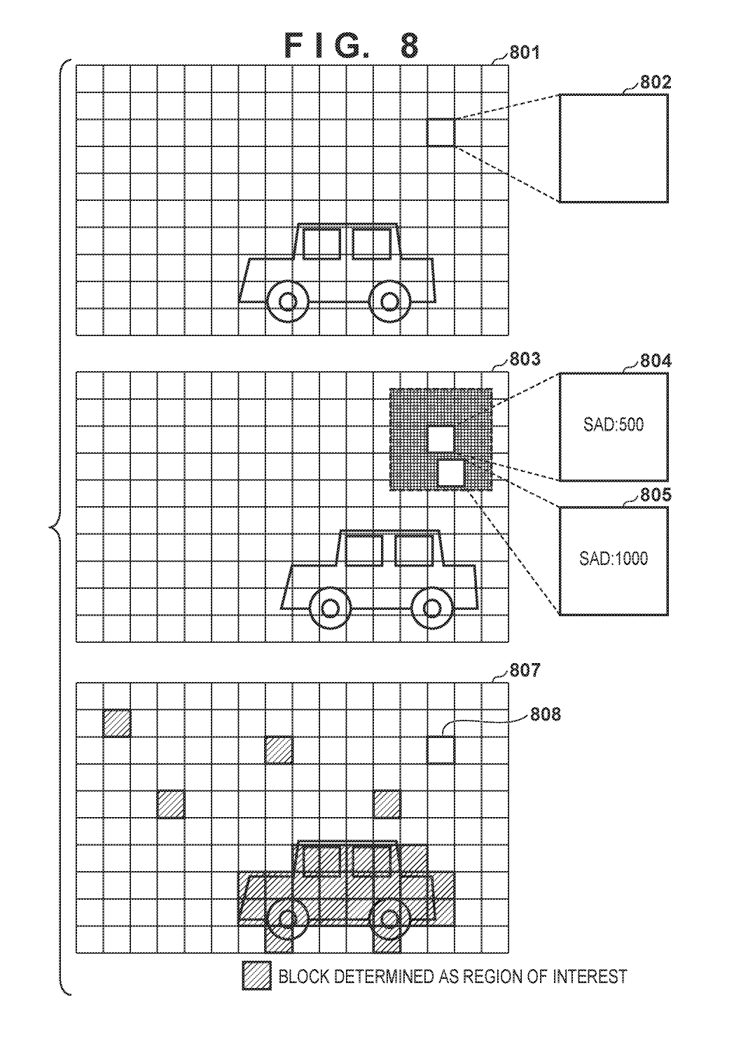

In contrast to this, in the present embodiment, important regions are determined based on the motion vectors of the large blocks. FIG. 8 shows an example of processing for a moving image in which motion vectors are searched for using large blocks and regions of interest and regions of non-interest are determined using the obtained motion vectors.

Also, an image 801 shown in FIG. 8 corresponds to the image 602 shown in FIG. 6, is a frame currently being encoded, and encoding is to be performed on a CTU 802. Similar blocks are searched for in the frames of the image 801 and the image 803. If the pixels vary due to noise as well, the number of pixels to be compared increases due to the sizes of the search blocks increasing.

If the large block 804 and the large block 805 of the image 803 are candidates for being similar blocks, the large block 804, which has a small SAD, is selected as the similar block (here, the SAD of the large block 804 is 500, and the SAD of the large block 805 is 1000).

In this manner, there is a low probability that a similar block exists at coordinates different from those of the CUT in which encoding is to be performed. That is, the number of blocks that are determined as similar blocks due to the sensor noise decreases in the regions in which no moving object exists. As a result, the motion vectors tend not to be generated as in the CTU 808 of the image 807, and therefore it is possible to reduce the number of cases in which needless regions of interest that originally are not necessary are extracted as in the image 807.

As described above, the moving image encoding apparatus 10 according to the present embodiment includes: a first detection unit (large block motion detection unit 101) that detects first motion information (motion vectors) in units of blocks of a first size (in units of large blocks) based on the moving image; a determination unit (region-of-interest determination unit 104) that determines the region of interest from the moving image based on the first motion information; a control unit (regional image quality control unit 105) that controls the quantized value of the block determined as being the region of interest such that it is set to a value lower than the quantized value of the block determined as not being the region of interest; a second detection unit (small block motion detection unit 102) that detects second motion information (motion vectors) in units of blocks with a second size (in units of small blocks) that is smaller than the first size, based on the moving image; and an encoding unit (encoding unit 103) that performs compression encoding on the moving image based on the second motion information and the quantized value set by the control unit.

According to the present embodiment, by determining the position of the region of interest in the captured moving image to be encoded based on the motion vector detected in units of large blocks, the region of interest can be estimated with erroneous detection suppressed. For this reason, the location that is to be the region of interest can suitably be given a high image quality. Also, the motion vectors encoded during motion compensation for encoding and the motion vectors to be used to determine the region of interest are different, but a reduction of the circuit scale and a decrease in power consumption can be expected by using the same processing in common up to a certain point. Furthermore, the motion vector to be used for estimation can be in the same frame as the captured moving image to be encoded, and thus an effect is demonstrated in which no additional buffer memory is needed.

In this manner, according to the present embodiment, it is possible to reduce the likelihood of being erroneously determined as a region of interest due to unimportant motion information that is caused by sensor noise, shaking, or the like, and the bit rate can be efficiently reduced while maintaining the image quality of the region that is to have a high image quality.

### Second Embodiment

In the first embodiment, an example was described in which erroneous detection of a region of interest is reduced by determining a region of interest in a captured moving image based on motion vectors output from the large block motion detection unit 101.

However, if the moving image input to the encoding unit is a video including a lot of sensor noise, when performing motion prediction, similar CTUs will be discovered in the range of searching for motion vectors also for CTUs that do not move and the motion vectors of large blocks will be generated in some cases. If the motion vectors of large blocks are generated in this manner, the large blocks will be erroneously determined as regions of interest by the region-of-interest determination unit 104 and setting will be performed by the regional image quality control unit 105 such that the image quality is high in some cases. Accordingly, in some cases, unnecessary regions are given higher image quality, which causes an increase in the bit rate.

In contrast to this, in the present embodiment, an example will be described in which master processing of low-order bits is implemented by the large block motion detection unit 101 and detection of similar blocks is performed with the pixel value of predetermined high-order bits.

Note that the configuration of the moving image encoding apparatus according to the present embodiment is similar to that of the first embodiment, and therefore specific description thereof is omitted here. Also, the processing content of the processing units is the same as in the first embodiment, except for the processing content of the large block motion detection unit 101 included in the moving image encoding apparatus being different, and therefore specific description thereof is omitted here.

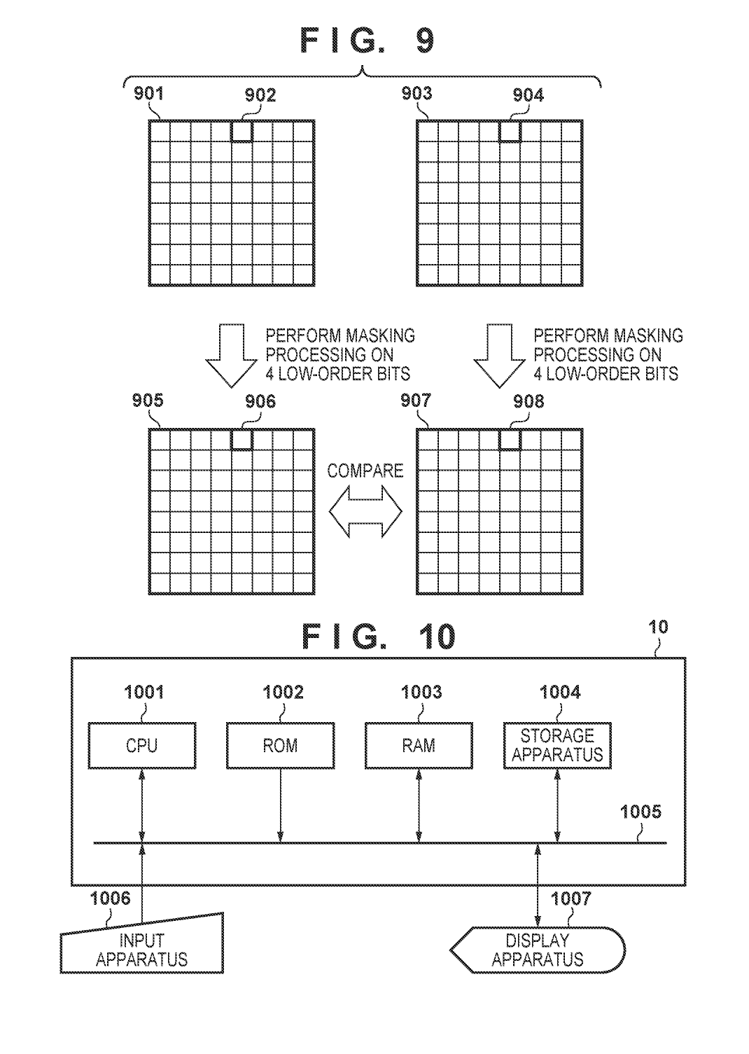

In motion search performed by the large block motion detection unit 101, as shown in FIG. 4 before, processing for comparing pixel values in the search range and discovering similar blocks is performed. Here, the large block motion detection unit 101 according to the present embodiment compares the pixel values of the pixel 902 of the 8×8 block 901 of the reference frame and the pixel 904 of the 8×8 block 903 of the frame to be encoded, as shown in FIG. 9. It is assumed that the pixel value of the pixel 902 was 11110110, and the pixel value of the pixel 904 was 11111110. Due to the processing for masking the predetermined bits (e.g., the 4 low-order bits) in the 8 bits of the pixel value being performed, comparison of only predetermined bits (e.g., the 4 high-order bits) is performed.

In this case, since the differences from 0 to 15 can be ignored, resistance to sensor noise can be further strengthened. It should be noted that although an example has been described in which the 4 low-order bits are compared in the present embodiment, the present invention is not limited thereto. As a result of implementing the above-described processing, the pixel value of the pixel 906 of the 8×8 block 905 of the frame being referenced is 11110000, the pixel value of the pixel 908 of the 8×8 block 907 of the frame to be encoded is 11110000, and both pixel values match.

As described above, in the present embodiment, when the block of the second frame, which is similar to the block of the first size of the first frame included in the moving image is to be detected by the large block motion detection unit 101, detection is performed by comparing the pixel values using the predetermined high-order bits of the pixel values. Thus, by performing masking processing on the low-order bits, comparison of only the pixel values of the predetermined high-order bits is performed, and therefore resistance to sensor noise is further strengthened.

According to the present invention, by reducing erroneous detection of regions of interest, it is possible to efficiently reduce the bit rate.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-033676, filed Feb. 27, 2018, which is hereby incorporated by reference wherein in its entirety.

What is claimed is:

1. A moving image encoding apparatus, comprising:
a first detection unit configured to detect first motion information in units of blocks of a first size from a moving image;
a determination unit configured to determine a region of interest from the moving image based on the first motion information;
a control unit configured to perform control such that a quantized value of a block determined as being the region of interest is set to a value lower than a quantized value of a block determined as not being the region of interest;
a second detection unit configured to detect second motion information in units of blocks of a second size that is smaller than the first size from the moving image, based on the first motion information; and
an encoding unit configured to perform compression encoding on the moving image based on the second motion information and the quantized value set by the control unit.

2. The moving image encoding apparatus according to claim 1, wherein the first detection unit calculates a first motion vector with integer precision as the first motion information.

3. The moving image encoding apparatus according to claim 1, wherein the second detection unit calculates a second motion vector with decimal precision as the second motion information.

4. The moving image encoding apparatus according to claim 1, wherein the first detection unit detects a block of a second frame that is similar to the block of the first size of the first frame included in the moving image, and detects a first motion vector between blocks as the first motion information.

5. The moving image encoding apparatus according to claim 4, wherein the second detection unit detects, in a predetermined range from a coordinate indicated by the first motion vector, a block of the second frame that is similar to a block of the second size, which is obtained by dividing a block of the first size in the first frame, and detects a second vector between blocks as the second motion information.

6. The moving image encoding apparatus according to claim 4, wherein if the size of the first motion vector exceeds a threshold, the determination unit determines the block determined by the first detection unit as the region of interest.

7. The moving image encoding apparatus according to claim 6, wherein the threshold is zero.

8. The moving image encoding apparatus according to claim 1, wherein when the first detection unit is to detect a block of a second frame that is similar to the block of the first size of the first frame included in the moving image, the first detection unit performs detection by performing comparison between pixel values using predetermined high-order bits of pixel values.

9. The moving image encoding apparatus according to claim 1, wherein the first size and the second size are determined based on a spatial frequency of pixels of the moving image.

10. A control method for a moving image encoding apparatus, the method comprising:
detecting first motion information in units of blocks of a first size from a moving image;
determining a region of interest from the moving image based on the first motion information;
performing control such that a quantized value of a block determined as being the region of interest is set to a value lower than a quantized value of a block determined as not being the region of interest;
detecting second motion information in units of blocks of a second size that is smaller than the first size from the moving image, based on the first motion information; and
performing compression encoding on the moving image based on the second motion information and the set quantized value.

11. A non-transitory computer-readable storage medium storing a computer program for causing a computer to execute a control method for a moving image encoding apparatus, the method comprising:
detecting first motion information in units of blocks of a first size from a moving image;
determining a region of interest from the moving image based on the first motion information;
performing control such that a quantized value of a block determined as being the region of interest is set to a value lower than a quantized value of a block determined as not being the region of interest;
detecting second motion information in units of blocks of a second size that is smaller than the first size from the moving image, based on the first motion information; and
performing compression encoding on the moving image based on the second motion information and the set quantized value.
